(19) United States
(12) Patent Application Publication
(10) Pub. No.: US 2017/0173502 A1
(43) Pub. Date: Jun. 22, 2017

(54) FILTER ELEMENT AND METHOD FOR PRODUCING A FILTER MEDIUM FOR SUCH A FILTER ELEMENT

(71) Applicant: HYDAC FLUIDCARECENTER GMBH, Sulzbach/Saar (DE)

(72) Inventors: Sven BRALL, Saarbruecken (DE); Richard EBERLE, Ormesheim (DE); Florian HOFFMANN, Merchweiler (DE)

(73) Assignee: HYDAC FLUIDCARECENTER GMBH, Sulzbach/Saar (DE)

(21) Appl. No.: 15/115,723

(22) PCT Filed: Feb. 7, 2015
(86) PCT No.: PCT/EP2015/000255

§ 371 Date: Aug. 1, 2016

(30) Foreign Application Priority Data
Feb. 13, 2014 (DE) 10 2014 002 033.9

(51) Int. Cl. B01D 29/21; B01D 39/20; A01N 43/80; B01D 29/00; F02M 37/22; A01N 59/00; B01D 39/16; B01D 39/14

(52) U.S. Cl. CPC B01D 29/216; B01D 39/163; B01D 39/2017; B01D 39/14; B01D 29/0093; F02M 37/22; A01N 59/00; A01N 43/80; B01D 2239/1291; B01D 2239/0654; B01D 2239/0442

(57) ABSTRACT

A filter element, in particular for treating fluids in the form of diesel fuel, has a filter medium (14) through which the fluid can flow. The filter medium (14) contains at least one active substance having antimicrobial properties.

### FIELD OF THE INVENTION

The invention relates to a filter element, in particular for treating fluids in the form of diesel fuel, comprising a filter medium through which the respective fluid can flow. The invention furthermore relates to a method for producing a filter medium for such a filter element.

### BACKGROUND OF THE INVENTION

Along with bacteria, slime-secreting microorganisms or fungi are also able to grow in fuels, especially in ones with an elevated or otherwise high water content. Not only can these organisms adversely affect the combustion process in the engine, but in particular they can also clog fuel line components such as those in the form of filter elements serving as fuel filters.

The slime formation is also known by the technical term “diesel plague”. It can also be responsible for corrosion damage to the fuel system. Microorganisms, especially ones present in diesel fuel, can cause the diesel fuel stored periodically and in some cases stored for longer periods in a tank to age and thereby be biodegraded in a disadvantageous and undesirable manner. Such corrosion and oxidation processes are further enhanced when biofuels are produced from biomass such as rape or soybeans, as these constitute an ideal nutrient medium for bacteria, microorganisms, and fungi.

### SUMMARY OF THE INVENTION

An object of the invention is to provide an improved filter element along with a method for producing an improved filter element that helps avoid the aforementioned effects that are perceived as disadvantageous in the area of diesel fuel filtering.

That object is basically achieved with a filter element and a method for producing the filter element having, as an essential unique feature of the invention, a filter medium with at least one active substance with antimicrobial properties. Owing to this property, any bacteria, microorganisms, or fungi present in the diesel fuel as well as comparable biological structures found in nature can be brought into a state in which they are no longer able to exert harmful or deleterious effects on the (bio)diesel fuel. This property likewise applies to the other fluid components such as the tank, the fuel lines, the fuel filter, the engine and its injection nozzles (common rail system), etc. Through the active destruction of the respective biological structure under the effect of the antimicrobial active substance, the biological structure is transformed into a state in which it is dissolved in the fluid such that the aforementioned biological feed material per se becomes a non-reactive component of the fluid, which non-reactive component can then run through diesel-hydraulic circuits or other working circuits in an obstruction-free manner.

In addition to controlling the aforementioned diesel plague, this active substance also ensures that fluid-conducting machine components of general design are protected against damage caused by biocorrosion. Furthermore, the diesel fuel is protected against biodegradation by the biological feed material such as bacteria, microorganisms, or fungi, etc. Furthermore, this protection results in longer filter lifetimes when using fuels with high proportions of biofuel fractions obtained from biomass, which in addition typically have an elevated water content. No equivalent to this active substance is present in the prior art. The method of the invention for producing a filter medium for the filter element described above is characterized in that the filter material forming the filter medium is at least provided with one filter layer in a coating bath with the respective active substance. This filter bath allows a particularly advantageous production of the respective filter element on a large industrial scale.

The statements above clearly demonstrate that “diesel fuel”, as used in this application, not only includes the typical mineral fuels, but also and even more so synthetic diesel fuel and in particular biodiesel. The main area targeted or use by the present invention is biodiesel fuel. According to Wikipedia, biodiesel (more rarely agrodiesel) is also known chemically as fatty acid methyl ester and is a fuel that is equivalent to mineral diesel fuel as far as use is concerned. The chemical industry typically produces biodiesel by esterification of vegetable or animal lipids and oils with monovalent alcohols, such as methanol or ethanol. According to the Wikipedia entry, synthetic fuel is a specific fuel that differs from conventional fuels (diesel, gasoline, kerosene, etc.) in that it is manufactured by a more complex process (alteration of the chemical structure). A distinguishing feature is a raw material source other than petroleum. Gaseous fuels such as hydrogen and methane, or oil products from unconventional raw material sources such as oil sand or oil shale are also classified as synthetic fuels.

In a particularly preferred embodiment of the filter element according to the invention, the respective active substance has at least one component that enables an ionic destruction of a bacterial cell wall and another component that allows a physical disruption of a bacterial cell membrane. Preferably, the active substance component bringing about the ionic destruction of the bacterial cell wall has a nitrogen content, preferably in the form of positively charged nitrogen molecules that cause biological feed material such as bacteria, microorganisms, and fungi present in the diesel fuel to be attracted and attach to the respective active substance in such a way that the biological feed material is forcibly fed within a gradient movement to the respective active substance, and at least one other component of the aforementioned active substance has preferably aliphatic hydrocarbon compounds, which then to a large extent or even completely destroy, but at least render reactively ineffective, the respective cell membrane or cell wall attached to the active substance.

If the respective filter element utilizes an active substance with a third active component that enables the active substance to bond chemically to the filter material of the filter medium, which is preferable, the action mechanism is then securely bound in the filter element material and cannot be unintentionally flushed out in the fluid or filtration mode.

Particularly in the hydrolyzed state, i.e., in the form of an aqueous solution, the third component can permanently engage on the filter element material by cross-linking and preferably intrinsically fix itself thereto by forming a chemical bond. Instead of binding by hydrolysis, special binder materials that preferably intrinsically allow a binding of the respective active substance to the filter medium of the filter element can be provided.

In another particularly preferred embodiment of the filter element solution according to the invention, the respective active substance is formed from a silicate compound, preferably in the form of an ammonium silicate compound. As an alternative, use can also be made of biocides, preferably a broad-spectrum biocide. If silicate compounds are used, these preferably are of organosilicon quaternary ammonium compounds or have an ammonium chloride content, for example within the compound 3-(trimethoxysilyl) propyl dimethyl octadecyl ammonium chloride.

If in addition or as an alternative, biocides are used as active substances, with preference given to using a broad-spectrum biocide such as octylisothiazolinone, for example.

For the filter medium to also fulfill the requirements for particle filtration in standard fashion, the filter medium preferably has a multi-ply pleated configuration. A ply on the upstream side of the diesel flow configured as a non-woven fabric or non-woven material preferably comprises the active substance described above.

The non-woven fabric or non-woven material per se preferably has a three-ply configuration. For increasing its stability in the fluid mode with the filter element, it can abut against a plastic grid that is preferably composed of a polyamide material.

Other objects, advantages and salient features of the present invention will become apparent from the following detailed description, which, taken in conjunction with the drawings, discloses preferred embodiments of the present invention.

### BRIEF DESCRIPTION OF THE DRAWINGS

Referring to the drawings that form a part of this disclosure and are schematic and not to scale:

FIG. 1 is a perspective and partially cutaway view of a filter element according to an exemplary embodiment of the invention, with the filter element being a changeable part;

FIGS. 2 and 3 graphically illustrate the structure of two different active substances with antimicrobial properties in the form of chemical structural formulas according to first and second exemplary embodiments of the invention, respectively;

FIG. 4 is a side view in cross section of the active substance ply with antimicrobial properties extending between two support plies of a filter medium, with the flow direction of the fluid through the filter medium indicated by an arrow X according to an exemplary embodiment of the invention; and

FIG. 5 is a side view in cross section of a production system for carrying out the method according to an exemplary embodiment of the invention, which is also known by the technical term “Fouler process” and is used to coat a preferably three-ply non-woven material, wherein the active substance or optionally an active substance in combination with a binder material is in the schematically illustrated coating bath.

### DETAILED DESCRIPTION OF THE INVENTION

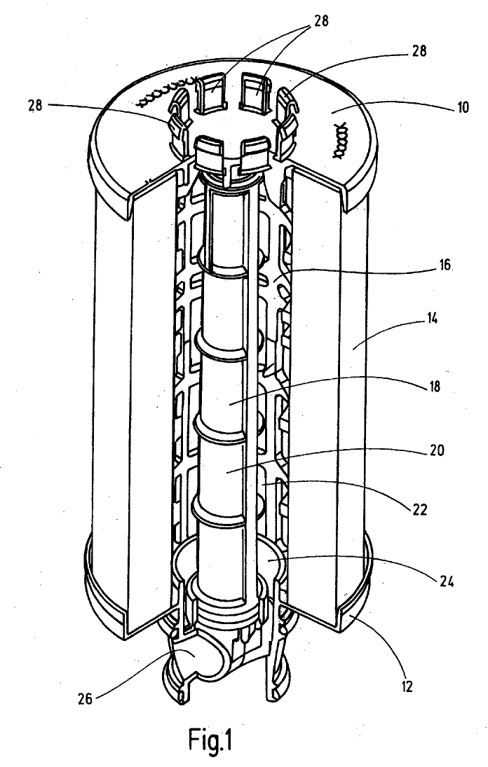

The filter element illustrated in FIG. 1 is configured as a fuel filter, in particular for (bio)diesel fuel. The filter element is part of a fuel supply system (not shown) for an internal combustion engine and is used to remove particulate contaminants from the aforementioned mineral diesel fuel, biodiesel, synthetic diesel or diesel oil prior to combustion in the engine. Because aqueous admixtures capable of adversely affecting the combustion process in the engine are frequently encountered in diesel fuel, the filter element shown in FIG. 1 also enables the separation of water from the diesel fuel. When such fluids do not contain any aqueous admixtures, the filter element can also be constructed more simply.

The filter element shown in FIG. 1 is designed as a replacement or changeable element, i.e., in a filter device not shown in any greater detail here. The used filter element can be replaced with a new element for filtering particles once more. The basic design of such filter elements as well as the use thereof in filter devices is prior art and disclosed in, for example WO 2011/107262 A1.

In the standard fashion for filter elements, on the two opposite ends, end caps 10, 12, form mounts for a filter medium 14 and for a fluid-permeable support tube 16 in abutment with the inner side of the filter medium. A water-repellent screen 20 surrounding the inner filter cavity 18 in a tube-like manner is located at a specifiable radial spacing from the support tube 16. For effecting a water separation, a filter medium 14 is used in such fuel filters that exerts a coagulating action on the water carried by the fuel, thus causing water to condense out in droplet form, and to collect in the intermediate space 22 between the inner circumference of the support tube 16 and the outer circumference of the water-repellent screen 20. Since the screen 20 is impermeable to coagulated water droplets, the water flows downward.

The illustrated intermediate space 22 thus forms a water separation system in which the water separated from the fuel flows down to the bottom end cap 12. Looking toward FIG. 1, the screen 20 configured as a hollow cylinder terminates at its bottom end, while still maintaining a radial spacing, in a preferably cylinder-shaped connecting piece 24 that is an integral component of the bottom end cap 12. Water can exit the filter element via the radial spacing to drain into a not illustrated water tank or into the surroundings, to which end the connecting piece 24 empties into the tank in the form of a water accumulator.

The bottom end of the water-repellent screen 20 empties into another connecting piece 26, which is fluid-conducting, in particular fuel-conducting, and which passes through the center of the connecting piece 24 and is then led at a right angle outside the zone of the connecting piece 24. The fuel line system, which can supply an internal combustion engine with diesel fuel or diesel oil, is then connected to this other connecting piece 26. Whereas the bottom end cap 12 is penetrated by the connecting pieces 24, 26, the top end cap 10 is configured as a closed lid piece and has projecting notches 28 for securing the filter element in the filter device (not shown in any greater detail here) of a fuel filtration and supply system.

The fluid passing through the filter element according to FIG. 1 is thus largely freed of both particulate contaminants and water by the filter medium 14 as it is fed from the dirty side on the outer circumference of the filter element into the filter cavity 18 serving as the clean side. If the fluid does not contain water, the filter medium 14 can then do without a droplet-forming, coagulating layer or an additional element having this effect.

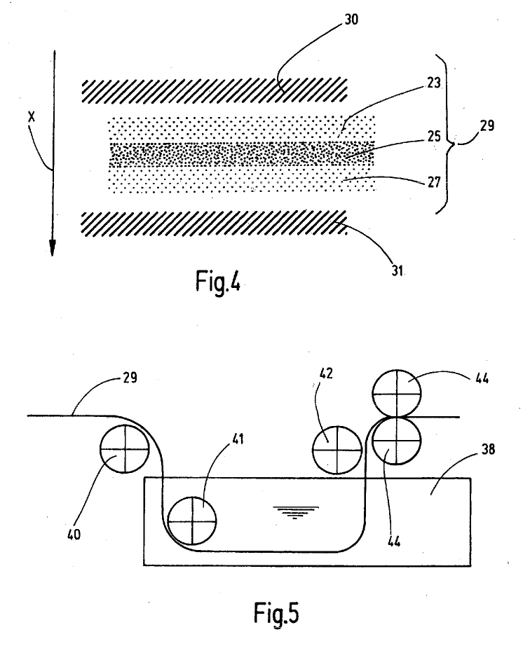

The filter medium 14 shown in FIG. 1 is wrapped around the cylindrical support tube 16 in the not illustrated pleated form of a filter pad. The effective filtering surface of the filter medium 14 is increased by the pleating. The foregoing notwithstanding, use can also be made of a hollow cylindrical filter medium for the filter element instead of a pleated filter element 14 as shown schematically in FIG. 1. Furthermore, the filter medium 14 according to the illustration of FIG. 4 has a multi-ply, in particular a three-ply configuration. The three- or multi-ply filter pad extends as the filtering component of the filter medium 14 between two support grids or support plies 30, 31. The actual proportions of the ply structure are only very roughly approximated in FIG. 4. The ply structure can comprise a pre-filter ply 23, a main filter ply 25, and also a protective non-woven ply 27. Depending upon the filtration task, the three-ply composite 29 can be supplemented in diverse ways with additional plies (not explained in any further detail nor shown here). The flow direction of the fluid is indicated by the arrow and designated by X in FIG. 4.

As a three-ply filter medium 14, use can be made of non-woven fabrics capable of achieving a β value of 100 for various particle sizes. For example, with a particle size of 7 μm, which basically corresponds to the pore size of the filter or of the respective filter ply, with a β value of 100 (β₁₀₀ value) on average 100 particles with a size of 7 μm or greater will be found retained on the upstream side of the filter for every one such particle 7 μm in size or greater found let through to the downstream side of the filter. This value corresponds to a filter efficiency value of 99%.

The following materials in particular, with β₁₀₀ values for particle sizes or pore sizes of 7 μm, 10 μm, or 30 μm, respectively, have proven to be suitable as three-ply non-woven fabrics:
β₁₀₀=7 μm: Ahlstrom Trinitex® Glass K959100 synthetic fibers (PET) with microglass fibers and binder;
β₁₀₀=10 μm: Ahlstrom Trinitex® K820100 synthetic fibers (PET) and special latex binder; and
β₁₀₀=30 μm: Ahlstrom Trinitex® K94970 synthetic fibers (PET) and binder.

The three-ply non-woven fabrics mentioned here and available under the brand name Trinitex permit a simultaneous binding of three wet laid layers 23, 25, 27 in a single operation, while maintaining the three-ply composite 29. The respective outer layer 23 and inner layer 27 can be composed of different materials, in particular ones made of natural and/or synthetic fibers.

The synthetic fibers designated with the abbreviation PET are made of polyethylene material, which in particular give rise to a fabric ply in which the respective fiber material for the particle separation is held in such a way that it cannot be flushed out. In addition to the aforesaid latex binder, epoxy- or acrylic-based binders can be used. Other binder structures for binding the individual plies are also possible here. To protect the sensitive non-woven fabric in wet laid, three-ply form, according to the illustration in FIG. 4, a lamellar protective grid 30, 31 is present on both sides, i.e., on the upstream side as well as the downstream side, which grid is preferably made of a polyamide material, in particular a PA6 material.

The specific details of the individual β₁₀₀ values given above are determined in accordance with the ISO Standard 19348.

To provide the multi-ply filter medium 14 with an antimicrobial active substance, a coating process involving a dip or coating bath 38 is employed, as exemplified in FIG. 5. The three-ply non-woven fabric 29 to be coated is guided by feed rollers 40 and guide rollers 41 into the dip bath 38 and coated therein. After the coating, the non-woven fabric 29 is guided out of the vat or bath 38 via a transport roller 42 and conveyed out of the bath unit via two squeeze rollers 44 acting as a pair, which squeeze rollers 44 are part of a calendering unit not shown in any greater detail here, for further processing outside the bath area. The purpose of the squeeze rollers 44 is to press out any superfluous coating material from the non-woven fabric 29. The squeeze rollers 44 are disposed above the bath 38 in such a way that superfluous coating material can return to the dip bath 38. The squeeze rollers 44 furthermore improve the bonding of the individual plies in the composite 29. The technical term “Fouler process” is also used to designate such dip bath or coating bath processes.

Possible antimicrobial active substances that can be used include the following in particular, which are listed with their trade names:
Sanitized® T99-19 (organosilicon quaternary ammonium compound),
Devan Chemicals Aegis™ 3-(trimethoxysilyl) propyl dimethyl octadecyl ammonium chloride, and
Sanitized® OIT (octylisothiazolinone).

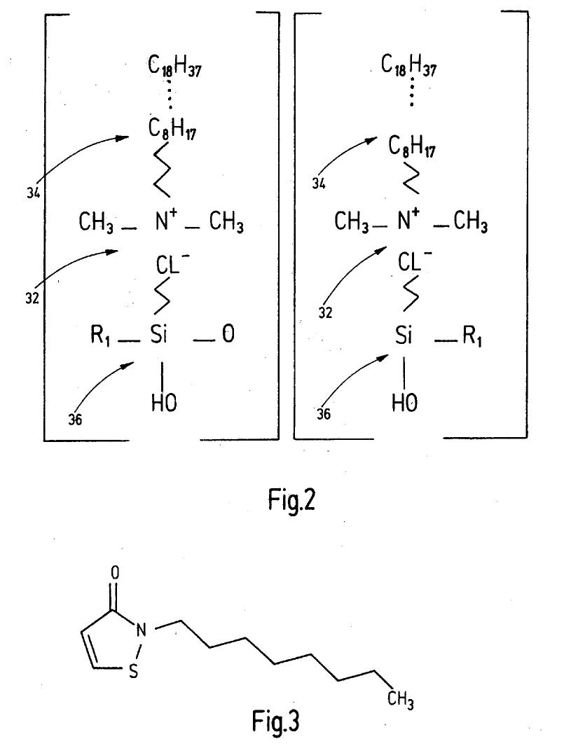

The mode of action for the antimicrobial active substances Sanitized® T99-19 and Devan Chemicals Aegis™ is shown in more detail in FIG. 2. The active substance component 32 in FIG. 2 allows the ionic destruction of the basically negatively-charged bacterial cell wall by short circuiting with the positive nitrogen molecule N⁺, whereas the second active substance component 34 effects the physical disruption of the bacterial cell membrane via the hydrocarbon chains of the active substance. Depending on the antimicrobial active substance used, the hydrocarbon chains are shorter (C₈H₁₇) or longer (C₁₈H₃₇) in configuration. A third active substance component 36 allows the chemical bonding of the active substance components 32 and 34 to the non-woven fabric 29 by cross-linking of the active substance molecules, which enable the aforesaid cross-linking preferably in aqueous solution (i.e., hydrolyzed). As seen in FIG. 2, the oxygen atom shown for the active substance illustrated on the left bonds with the Si group of the active substance illustrated on the right, thereby giving rise to a composite active substance composed of individual (partial) active substances having essentially the same structure.

If the basic mode of action for a broad spectrum biocide in the form of the active substance Sanitized® OIT is represented in FIG. 3, this active substance not only has a toxic but also a mutagenic effect on bacteria, microorganisms, and fungi. A nitrogen group on which a toxic and/or a mutagenic active substance component, preferably in the form of a CH₃ group, is adsorbed serves in turn for attracting the respective biological substance or structure. If such chemical biocides are used, these biocides must be bonded, particularly intrinsically and preferably with a binding agent, on the non-woven fabric 29 in the dip bath 38, as described in more detail above. The use of such binders can be dispensed with for the active substance components shown in FIG. 2 because such materials bind very well with the wet laid non-woven fabric 29, a process that is facilitated by the aforementioned cross-linking of the active substance molecules in aqueous solution via the component 36.

Instead of the dip bath 38, use can also be made of other coating processes, for example in the scope of surface coatings. The respective antimicrobial active substance could also be applied to a separate ply layer, which would then be folded in with the pleating of the other filter medium 14 on the upstream side. Also conceivable is providing separate filter plies and filter media with the respective antimicrobial active substance only, which would then effect the destruction of the respective biological substance, notably as pre-filters upstream of the actual filter element.

Through the use of antimicrobial active substances, a stabilization of the filter differential pressure against the influence of microorganisms is achieved and the diesel plague with its damaging effects is effectively counteracted.

While various embodiments have been chosen to illustrate the invention, it will be understood by those skilled in the art that various changes and modifications can be made therein without departing from the scope of the invention as defined in the claims.

1-11. (canceled)

12. A filter element for treating fluids in the form of diesel fuel, comprising:
a filter medium through which a respective fluid can flow, said filter medium having at least one active substance with antimicrobial properties.

13. The filter element according to claim 12 wherein
said active substance has at least a first component enabling an ionic destruction of a bacterial cell wall and a second component enabling a physical disruption of a bacterial cell membrane.

14. The filter element according to claim 13 wherein
active substance has a third component enabling a chemical bonding of the active substance to a filter material of the filter medium.

15. The filter element according to claim 12 wherein
said active substance comprises at least one of a silicate compound or at least one biocide.

16. The filter element according to claim 15 wherein
said silicate compound comprises an ammonium silicate compound.

17. The filter element according to claim 15 wherein
said biocide comprises a broad-spectrum biocide.

18. The filter element according to claim 15 wherein
said silicate compound is at least one of an organosilicon quaternary ammonium compound or a 3-(trimethoxysilyl) propyl dimethyl octadecyl ammonium chloride compound.

19. The filter element according to claim 15 wherein
said biocide comprises octylisothiazolinone.

20. The filter element according to claim 12 wherein
said active substance has a nitrogen content, that attracts bacteria, microorganisms and fungi, and has hydrocarbon compounds in aliphatic form that destroy cell walls or cell membranes of the bacteria, microorganisms and fungi in an attached condition.

21. A filter element according to claim 20 wherein
said nitrogen content is in a form of positively charged nitrogen molecules.

22. The filter element according to claim 12 wherein
said active substance is intrinsically bonded with the filter medium in at least one of hydrolyzed form or by a binding agent.

23. The filter element according to claim 12 wherein
said filter medium has a multi-ply configuration with a first ply on an upstream side of the fluid flow and configured as a non-woven fabric containing said active substance.

24. The filter element according to claim 23 wherein
said non-woven fabric has a 3-ply configuration and abuts against a plastic grid of a polyamide material.

25. A method for producing a filter medium for a filter element, comprising the steps of:
providing at least one ply of a filter material forming a filter medium; and
providing an active substance with antimicrobial properties in the filter medium by placing the filter medium in a coating bath.
